(19) United States
(12) Patent Application Publication
(10) Pub. No.: US 2008/0136117 A1
(43) Pub. Date: Jun. 12, 2008

(54) ANNULAR SELF-SUPPORTING, SELF-INDEXING GASKET AND JOINT FOR USE OF SAME

(76) Inventors: Thomas O. Roe, Stoughton, WI (US); David Toy, Madison, WI (US)

Correspondence Address: Kunzler & McKenzie, 8 EAST BROADWAY, SUITE 600, SALT LAKE CITY, UT, 84111, US

(21) Appl. No.: 11/609,228

(22) Filed: Dec. 11, 2006

(51) Int. Cl. F16J 15/24

(52) U.S. Cl. 277/530

(57) ABSTRACT

An apparatus is disclosed that includes a gasket having an annular shape characterized by an outer circumference and an inner circumference. The gasket is characterized by an inner thickness, proximate the inner circumference, tapering to an outer thickness, proximate the outer circumference. The inner thickness of the gasket is substantially greater than the outer thickness. A support member is integrated into the gasket to provide radial support to the gasket. In selected embodiments, one or more indexing features may also be integrated into the gasket to properly align and “clock” cylindrical sections sealed by the gasket.

### BACKGROUND OF THE INVENTION

1. Field of the Invention

This invention relates to gaskets and more particularly to annular self-supporting, self-indexing gaskets and joints for use of same.

2. Description of the Related Art

Emission standards, which set specific limits with respect to the amount of pollutants that may be released into the environment, are becoming more and more stringent. For example, current EPA guidelines continue to reduce allowable diesel exhaust emissions, with current acceptable emissions approaching zero. Although this may be positive for the environment, these regulations create a significant challenge to engine manufacturers.

For manufacturers of diesel engines, complying with current emissions standards may require use and development of a combination of techniques, including but not limited to exhaust gas recirculation (EGR), crank-case ventilation, and exhaust after-treatments systems. After-treatment systems, in particular, may include various components for treating exhaust. These components may include, for example, diesel oxidation catalysts (DOC), diesel particulate filters, selective catalytic reduction systems, or the like.

In certain situations, after-treatment systems may be provided in the form of a canister, resembling a muffler, used to replace or supplement a conventional muffler. This canister may be provided in cylindrical sections to facilitate servicing and replacement of the internal components of the after-treatment system or to remove or replace the sections themselves. These sections typically require serviceable joints to prevent leakage of exhaust gases between the sections.

In many after-treatment systems, the cylindrical sections of the canister are flared outward by ninety degrees to accommodate flat gaskets or flat formed beaded joints. Other joints use round gaskets contacting flat or machined surfaces of the flared sections. The gaskets used to seal these joints are typically constructed of graphite materials that are resistant to high temperatures and capable of preventing gas leakage. These gaskets are usually soft and compressible to provide an effective seal. However, the soft compliant characteristics of the gasket also make them more vulnerable to distortion and crushing where there is not proper support. Furthermore, although functional, the joints of current after-treatment systems make it difficult and time-consuming to clamp the sections of the after-treatment system together.

In view of the foregoing, what is needed is an improved joint that provides additional clamping force between the sections and an improved ability to retain the clamping force generated. Further needed are novel gaskets to provide a seal in such a joint. Ideally, such a joint would provide improved durability, significantly lower costs, and easier installation and service.

### SUMMARY OF THE INVENTION

The present invention has been developed in response to the present state of the art, and in particular, in response to the problems and needs in the art that have not yet been fully solved by currently available apparatus. Accordingly, an improved joint has been developed for use with an after-treatment system or other similar or related device. Further disclosed is a novel gasket to provide a seal in such a joint.

In one aspect of the invention, an apparatus in accordance with the invention includes a gasket having an annular shape characterized by an outer circumference and an inner circumference. The gasket is characterized by an inner thickness, proximate the inner circumference, tapering to an outer thickness, proximate the outer circumference. The inner thickness of the gasket is substantially greater than the outer thickness. A support member is integrated into the gasket to provide radial support to the gasket.

In certain embodiments, the support member includes a cylindrical structure integrated into the gasket. The cylindrical structure may include flanges extending axially from the gasket. In selected embodiments, one or more indexing features, such as grooves, notches, apertures, indentations, slots, or the like, may be integrated into the gasket or support member to properly “clock” (i.e., rotationally align) cylindrical sections relative to one another.

In selected embodiments, the support member includes a reinforcing ring integrated into the gasket. Accordingly, the gasket may include a channel, groove, or the like to accommodate the reinforcing ring. In certain embodiments, the gasket and support member are a monolithic structure. In other embodiments, the gasket and support member are separate components that are integrated into a single structure.

In another aspect of the invention, an assembly or “joint” in accordance with the invention includes a pair of cylindrical sections having flares along their respective circumferences. A gasket having an annular shape provides a seal between the flares. One or more indexing features, such as grooves, notches, apertures, indentations, slots, or the like, are integrated into the gasket to properly “clock” the cylindrical sections relative to one another. A V-band clamp may be provided to contact and urge the flares of the cylindrical section toward one another, thereby compressing the gasket to create a seal therebetween.

In selected embodiments, the gasket is characterized by an outer circumference and an inner circumference. The gasket is further characterized by an inner thickness, proximate the inner circumference, which tapers to an outer thickness, proximate the outer circumference. The inner thickness is substantially greater than the outer thickness.

In certain embodiments, a support member is integrated into the gasket to provide radial support to the gasket and to maintain its position between the flares of the cylindrical sections. In selected embodiments, the support member includes a cylindrical structure creating flanges extending axially from the gasket. In other embodiments, the support member includes a reinforcing ring integrated into the gasket.

In another aspect of the invention, an assembly or “joint” in accordance with the invention includes a pair of cylindrical sections having flares along their respective circumferences. A gasket having an annular shape provides a seal between the flares. A support member is integrated into the gasket to provide radial support thereto and maintain the position of the gasket between the flares of the cylindrical sections. A V-band clamp may be provided to contact and urge the flares toward one another, thereby compressing the gasket and creating a seal.

The present invention relates to an improved joint for use with an after-treatment system or other similar or related device. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a perspective view of one embodiment of an after-treatment system showing an exemplary application for a gasket and joint in accordance with the invention;

FIG. 2 is a perspective cutaway view of a joint showing one embodiment of a gasket and support member in accordance with the invention;

FIG. 3 is a perspective cutaway view of one embodiment of a gasket and support member in accordance with the invention;

FIG. 4 is a perspective cutaway view of a joint showing another embodiment of a gasket and support member in accordance with the invention;

FIG. 5 is an exploded perspective view of selected components of a joint, showing a gasket and support member incorporating various indexing features, in accordance with the invention; and

FIG. 6 is a perspective view of one embodiment of a V-band clamp used with a joint in accordance with the invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of apparatus in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

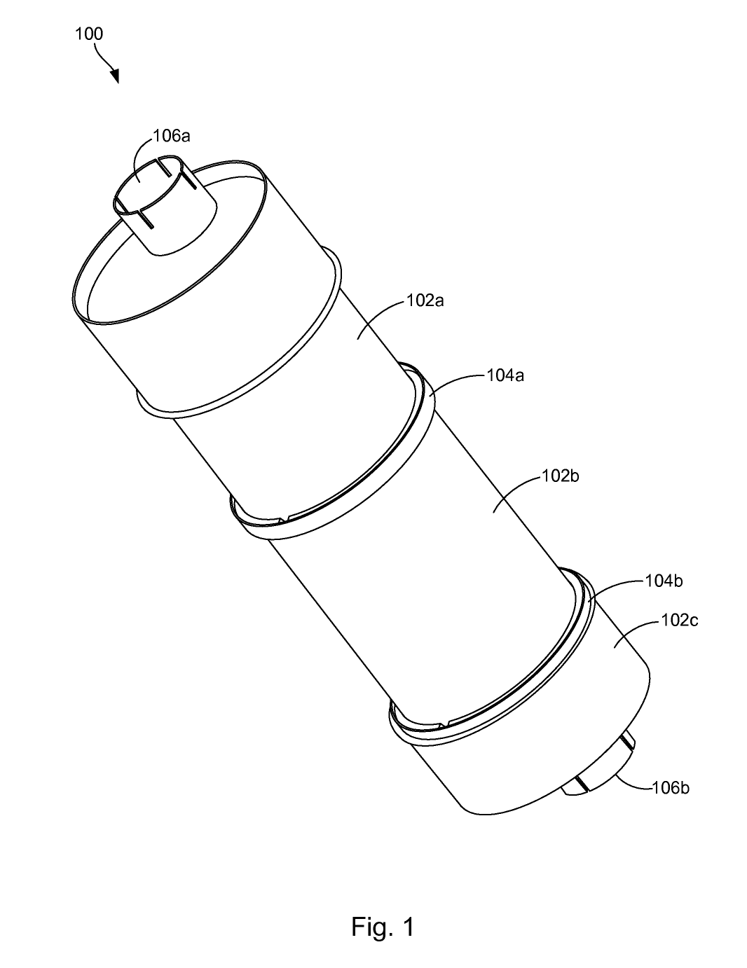

FIG. 1 illustrates one embodiment of an after-treatment system 100 for use with a joint and gasket in accordance with the invention. Although particular reference is made herein to an after-treatment system 100, the joint and gasket described herein may be used in various different systems or devices. Thus, the joint and gasket is not limited to use with after-treatment systems 100. For example, a joint and gasket in accordance with the invention may be used with mufflers, catalytic converters, exhaust pipes, or other devices requiring a coupling and seal between two cylindrical tubular sections. Thus, the illustrated after-treatment system 100 is simply one exemplary application among many for the joint and gasket disclosed herein.

In certain embodiments, an exhaust after-treatment system 100 may resemble a cylindrical canister and may be used to replace or supplement a conventional muffler. Such a system 100 may include an inlet 106a, an outlet 106b, and two or more cylindrical sections 102a-c. Dividing the system 100 into cylindrical sections 102a-c may enable service and replacement of various internal components of the after-treatment system 100, as well as individual removal or replacement of the sections 102a-c themselves. In selected embodiments, the cylindrical sections 102a-c may be used to house one or more exhaust treatment devices such as but not limited to diesel oxidation catalysts (DOC), diesel particulate filters, selective catalytic reduction systems, and the like. To prevent the escape of untreated emissions or other gases from the system 100, the cylindrical sections 102a-c may include serviceable joints 104a, 104b. These joints 104a, 104b create a seal between the sections 102a-c while enabling the after-treatment system 100 to be dismantled for repair, replacement, and servicing.

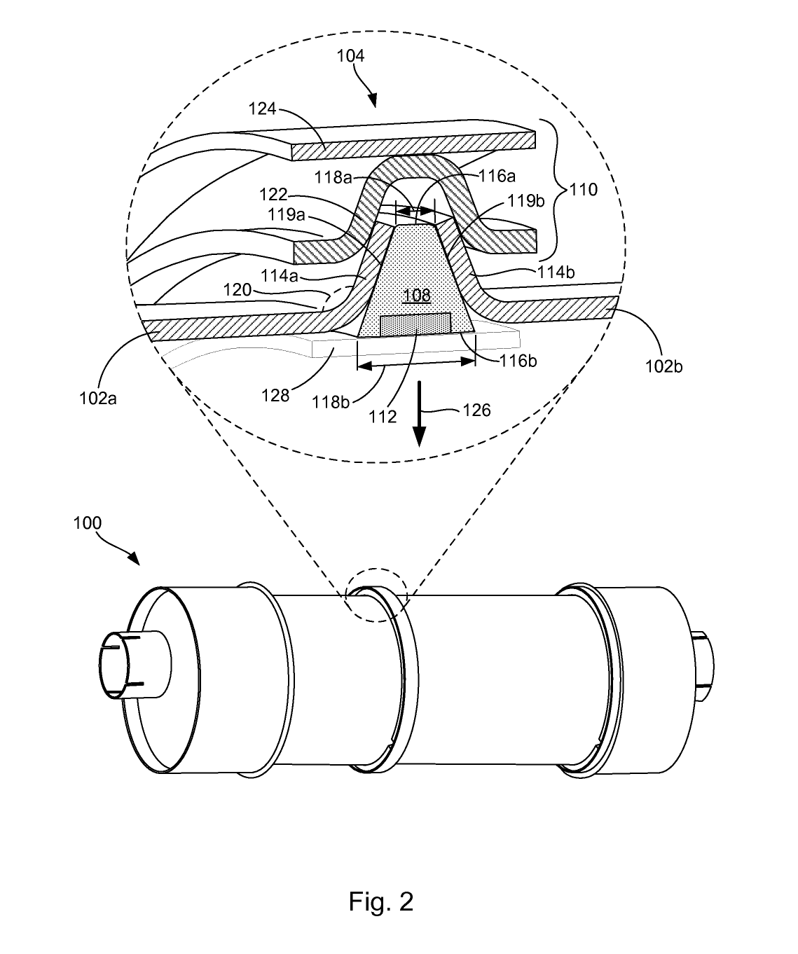

Referring to FIG. 2, in selected embodiments, a joint 104 in accordance with the invention may include a gasket 108, a V-clamp 110, and a support member 112. The gasket 108 may be inserted between flares 114a, 114b of the cylindrical sections 102a, 102b to provide a seal therebetween. The gasket 108 may be in an annular, or “donut,” shape and be characterized by an outer circumference 116a and an inner circumference 116b. The gasket 108 may further have an inner thickness 118b, proximate the inner circumference 116b, tapering to an outer thickness 118a, proximate the outer circumference 116a. The inner thickness 118b may be substantially greater than the outer thickness 118a to give the gasket 108 a tapered profile.

The gasket 108 may include a first contact surface 119a extending between the inner circumference 116b and outer circumference 116a. A second contact surface 119b, opposite the first contact surface 119a, may extend between the inner circumference 116b and outer circumference 116a. The gasket 108 may be constructed of various soft or compressible materials, such as graphite-based materials, that are resistant to high temperatures while providing an effective seal to prevent the leakage of emissions.

The flares 114a, 114b may form an obtuse (i.e., greater than ninety degree) angle 120 relative to the cylindrical sections 102a, 102b in order to conform to the tapered profile of the gasket 108. An angle 120 of about 110 degrees may be suitable, although the angle may be varied within a range of about 95 to 170 degrees. A V-clamp 110, which may include a V-band 122 and a tension strap 124, may be used to urge the flares 114a, 114b together to compress the gasket 108. That is, the V-band 122 may urge the flares 114a, 114b together as it is pressed over the flares 114a, 114b in the direction 126 by the tension strap 124.

Due to the angle 120 of the flares 114a, 114ba and the tapered profile of the gasket 108, the gasket 108 may tend to migrate in the direction 126 upon tightening the V-clamp 110. This is due to the radial force exerted on the gasket 108 in the direction 126. To counteract this force and keep the gasket 108 positioned between the flares 114a, 114b, a support member 112 may be integrated into the gasket 108 to provide radial support thereto. The support member 112 may be an annular structure, such as a reinforcing ring, made of a suitable metal, alloy, composite, or other material capable of providing the desired amount of radial support. In selected embodiments, the support member 112 may reside in a channel or groove formed in the gasket 108. An inner surface of the support member 112 may sit flush with an inner surface 116b of the gasket 108. The integrated support member 112 may eliminate the need to provide an independent support member 128 (shown by the dotted lines) along the inner circumference 116b of the gasket 108. This may reduce cost and complexity by reducing the number of components.

The tapered profile of the gasket 108 and flares 114a, 114b may provide various engineering advantages and cost savings compared to joints utilizing a ninety-degree flare and flat gasket approach. For example, the tapered profile of the flares 114a, 114b enables the V-clamp 110 to exert a greater clamping force on the flares 114a, 114b and to better retain the clamping force generated. This, in turn, provides a seal that is robust and reliable in preventing exhaust leaks. The angled flares 114a, 114b may also be easier and cheaper to form on the cylindrical sections 102a, 102b that ninety-degree or other more complicated flares. The joint 104 is also easy to install and service and provides better interaction between the V-clamp 110 and flares 114a, 114b. The resulting joint 104 thus provides a solution that is robust while cost-effective.

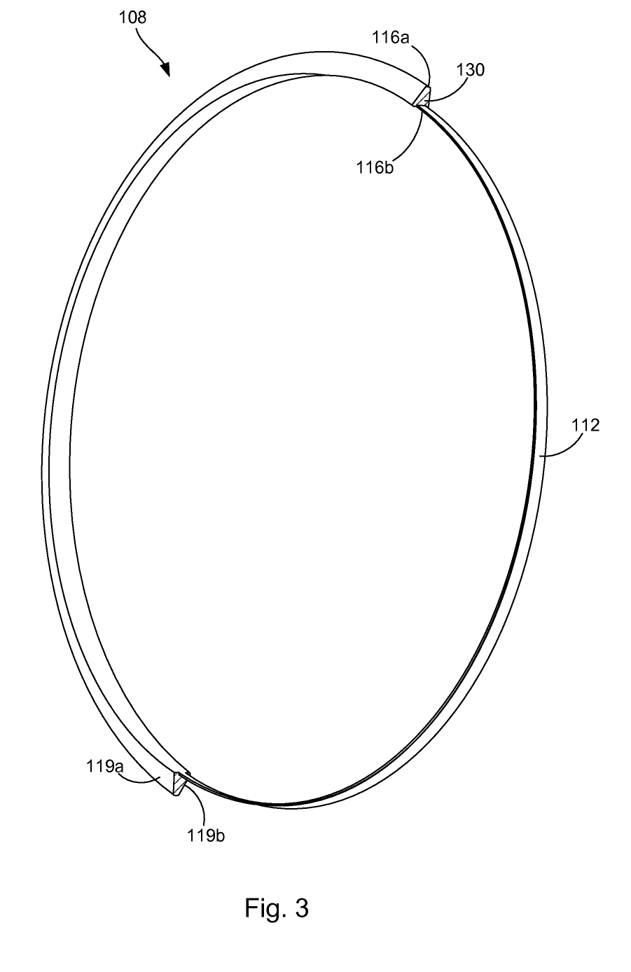

FIG. 3 is a perspective cutaway view of the gasket 108 illustrated in FIG. 2 with the annular support member 112 left intact. As illustrated, the gasket 108 is characterized by an annular, or “donut,” shape. A cross-sectional area 130 of the gasket 108 may have a substantially triangular or trapezoidal shape 130 to give the gasket 108 its tapered profile. Other tapered cross-sectional shapes 130 are also possible. The illustrated gasket 108 includes a first contact surface 119a extending between the inner and outer circumferences 116a, 116b. A second contact surface 119b, opposite the first contact surface 119a, also extends between the inner and outer circumferences 116a, 116b. These contact surfaces 119a, 119b are pressed against the flares 114a, 114b of the cylindrical sections 102a, 102b to seal the joint 104. As previously described, an annular support member 112 may be integrated into the gasket 108 to provide radial support thereto.

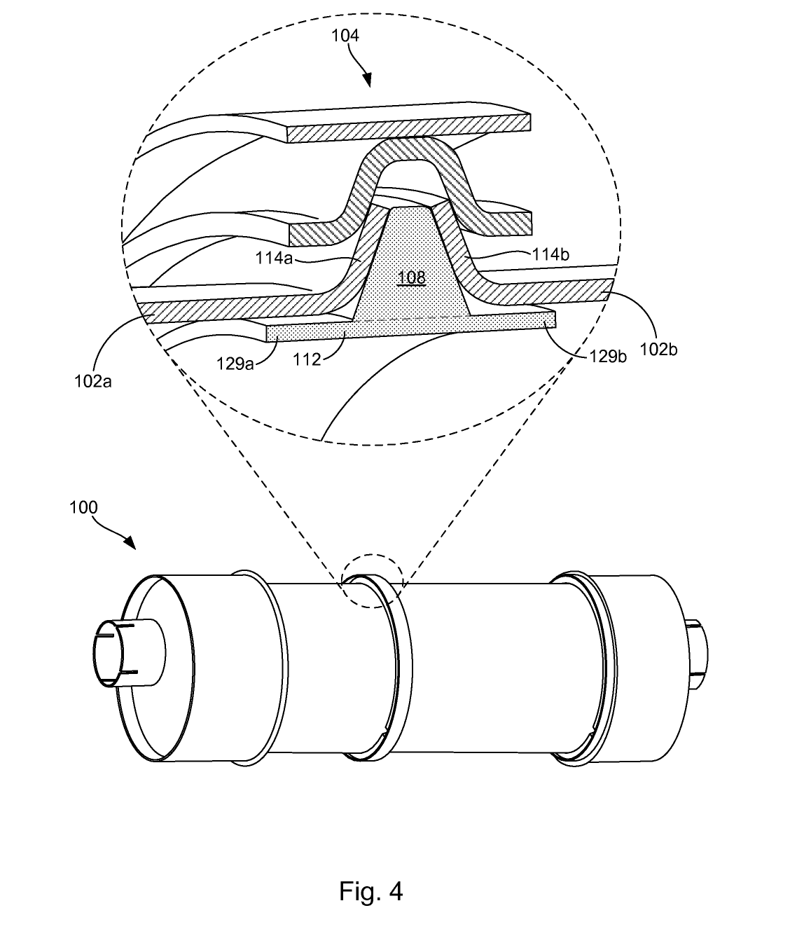

Referring to FIG. 4, in selected embodiments, the support member 112 may include a cylindrical structure 112 integrated into the gasket 108. This cylindrical structure 112 may include flanges 129a, 129b that extend axially from the gasket 108. Like the previous example, the support member 112 may provide radial support to the gasket 108 to ensure that the gasket 108 stays positioned between the flares 114a, 114b of the cylindrical sections 102a, 102b. The flanges 129a, 129b may also keep the gasket 108 properly positioned between the flares 114a, 114b by maintaining contact with the inside diameter of the cylindrical sections 102a, 102b. As will be explained in more detail hereafter, the flanges 129a, 129b may also incorporate one or more indexing features to keep the cylindrical sections 102a, 102b properly aligned, or “clocked,” relative to one another.

In certain embodiments, both the gasket 108 and support member 112 may be a single monolithic structure. In other embodiments, however, the gasket 108 and support member 112 may be separate components that are integrated or coupled together to create a single structure. For example, the gasket 108 may be constructed of a softer more compliant material while the support member 112 is constructed of a more rigid material providing the desired radial support. The gasket 108 and support member 112 may then be welded or attached together to create a single structure.

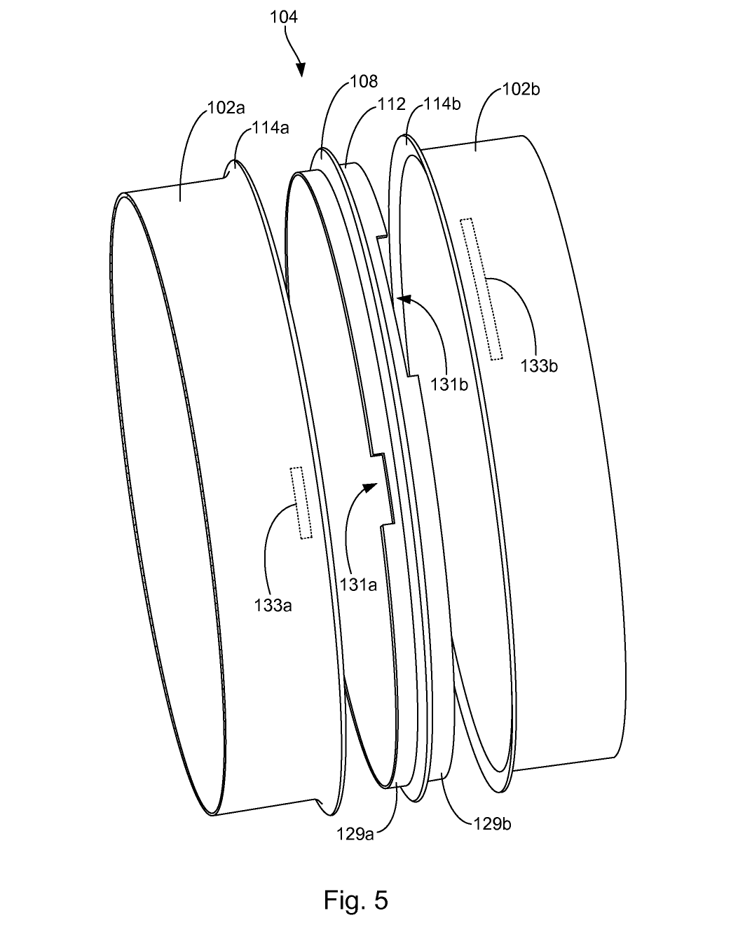

FIG. 5 is an exploded perspective view of a joint 104 showing one embodiment of a gasket 108, support member 112, and cylindrical sections 102a, 102b. The V-clamp 110 is not shown to avoid obstructing the view of other components. As shown, the cylindrical sections 102a, 102b include flares 114a, 114b that interface with and contact the gasket 108. A support member 112 with flanges 129a, 129b is included to provide radial support to the gasket 108 and maintain its position between the flares 114a, 114b.

In certain cases, the cylindrical sections 102a, 102b of an after-treatment system 100 may include devices such as pressure and temperature sensors that require a certain rotational position, or “clocking,” in the system 100. This function has previously been provided by rings or other features welded into the body of an after-treatment system. To provide proper “clocking” of the cylindrical sections 102a, 102b, indexing features 131a, 131b, such as one or more notches (as illustrated), grooves, apertures, indentations, slots, or the like, may be integrated into the support member 112 or gasket 108. These indexing features 131a, 131b may engage complementary features 133a, 133b of the cylindrical sections 102a, 102b to ensure that the sections 102a, 102b are properly clocked relative to one another. By integrating the indexing features 131a, 131b into the gasket, the need to weld rings or other features into the cylindrical sections 102a, 102b is reduced or eliminated, potentially reducing costs.

In addition to properly “clocking” the cylindrical sections 102a, 102b, the indexing features 131a, 131b also enable the gasket 108 to self-align. This also prevents improper installation of the cylindrical sections 102a, 102b during production and service. In certain embodiments, the support member 112 may also act as a guide to axially align the cylindrical sections 102a, 102b relative to one another when assembling the joint 104. In certain embodiments, the support member 112 may fit snugly within the inside diameter of the cylindrical sections 102a, 102b while still allowing axial movement (e.g., sliding) of the cylindrical sections 102a, 102b relative to the support member 112.

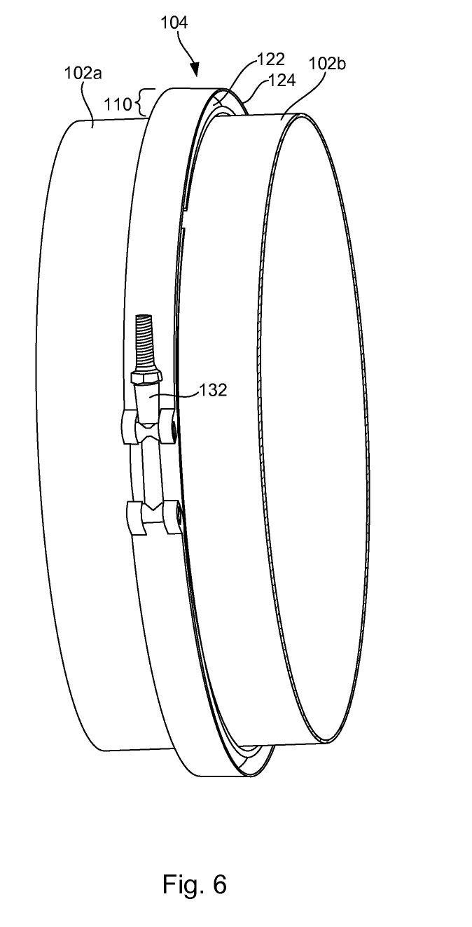

Referring to FIG. 6, once the gasket 108 and support member 112 are properly installed and positioned in the joint 104, the V-band clamp 110 may be tightened to urge the cylindrical sections 102a, 102b together and compress the gasket 108. As illustrated, a tension strap 124 of the V-band clamp 110 may include a bolt 132 or other fastener 132 to selectively increase or decrease tension in the strap. This tension compresses the V-band 122 which in turn urges the tapered flares 114a, 114b of the cylindrical sections 102a, 102b together.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a gasket having an annular shape and characterized by an outer circumference and an inner circumference, the gasket further having an inner thickness, proximate the inner circumference, tapering to an outer thickness, proximate the outer circumference, the inner thickness being substantially greater than the outer thickness; and
a support member integrated into the gasket to provide radial support to the gasket.

2. The apparatus of claim 1, wherein the support member comprises a cylindrical structure integrated into the gasket, the cylindrical structure having flanges extending axially from the gasket.

3. The apparatus of claim 2, further comprising at least one indexing feature integrated into at least one of the gasket and the support member.

4. The apparatus of claim 3, wherein the indexing feature comprises at least one of a groove, a notch, an aperture, an indentation, and a slot.

5. The apparatus of claim 1, wherein the support member comprises a reinforcing ring integrated into the gasket.

6. The apparatus of claim 5, further comprising at least one of a channel and a groove in the gasket to accommodate the reinforcing ring.

7. The apparatus of claim 1, wherein the gasket and support member are a monolithic structure.

8. The apparatus of claim 1, wherein the gasket and support member are separate components integrated into a single structure.

9. The apparatus of claim 1, wherein the gasket is characterized by at least one of a substantially triangular and a substantially trapezoidal cross-section.

10. An assembly comprising:
a first cylindrical section having a first flare along a circumference thereof;
a second cylindrical section having a second flare along a circumference thereof;
a gasket having an annular shape to provide a seal between the first and second flares; and
at least one indexing feature integrated into the gasket to properly align the first cylindrical section relative to the second cylindrical section.

11. The assembly of claim 10, wherein the a gasket is characterized by an outer circumference and an inner circumference, the gasket further having an inner thickness, proximate the inner circumference, tapering to an outer thickness, proximate the outer circumference, the inner thickness being substantially greater than the outer thickness.

12. The assembly of claim 10, further comprising a support member integrated into the gasket to provide radial support to the gasket, the support member maintaining the position of the gasket between the first and second flares.

13. The assembly of claim 10, further comprising a V-band clamp to contact and urge the first and second flares toward one another to compress the gasket.

14. The assembly of claim 10, wherein the support member comprises a cylindrical structure integrated into the gasket, the cylindrical structure having flanges extending axially from the gasket.

15. The assembly of claim 10, wherein the indexing feature comprises at least one of a groove, a notch, an aperture, an indentation, and a slot.

16. The assembly of claim 11, wherein the support member comprises a reinforcing ring integrated into the gasket.

17. The assembly of claim 11, wherein the gasket and support member are a monolithic structure.

18. The assembly of claim 11, wherein the gasket and support member are separate components integrated into a single structure.

19. An assembly comprising:
a first cylindrical section having a first flare along a circumference thereof;
a second cylindrical section having a second flare along a circumference thereof;
a gasket having an annular shape to provide a seal between the first and second flares; and
a support member integrated into the gasket to provide radial support to the gasket, the support member maintaining the position of the gasket between the first and second flares.

20. The assembly of claim 19, further comprising a V-band clamp to contact and urge the first and second flares toward one another to compress the gasket.
